(19) United States
(12) Patent Application Publication
(10) Pub. No.: US 2017/0078226 A1
(43) Pub. Date: Mar. 16, 2017

(54) COMMUNICATION ADAPTATION

(71) Applicant: AT&T Intellectual Property I, L.P., Atlanta, GA (US)

(72) Inventors: Brian Kevin Daly, Peachtree Corners, GA (US); DeWayne A. Sennett, Redmond, WA (US); Thomas P. Breen, Snellville, GA (US); George Stanek, Somerset, NJ (US); Charles Peter Musgrove, Henderson, NV (US)

(21) Appl. No.: 14/853,809

(22) Filed: Sep. 14, 2015

(51) Int. Cl. H04L 12/58; H04W 4/22

(52) U.S. Cl. CPC H04L 51/066; H04W 4/22

(57) ABSTRACT

Communication adaptation may be used to facilitate communications between devices where the communications are of a type unsupported by a recipient. In an example configuration, communication adaptation may be used to adapt emergency MMS messages sent to multiple recipients to an individual SMS message sent to an emergency services PSAP gateway while separately communicating the MMS message to the other recipients.

### BACKGROUND

Emergency services rely on timely, accurate, and reliable communications in order to respond to crisis situations effectively. Individuals contacting emergency services traditionally have used basic voice service communications over Public Switched Telephone Network (PSTN) or cellular lines. As network and phone technology has evolved, the United States Federal Communications Commission (FCC) has introduced regulations requiring network operators to be able determine the location of a caller contacting 911. However, effective approaches are needed to address situations where a person attempting to contact emergency services does not utilize traditional voice communications. More generally, effective solutions for cross-platform mobile communications are necessary and desirable.

### SUMMARY

As disclosed herein, communication adaptation may be used for multimedia messaging service (MMS) messaging to emergency services, such as 911. Also, as disclosed herein, communication adaptation may be used for providing cross-platform mobile communications.

In an aspect, an apparatus is disclosed including a processor, a memory coupled to the processor, the memory comprising executable instructions that when executed by the processor cause the processor to effectuate operations comprising: responsive to receiving a first electronic message of a first type, determining that the first electronic message contains a first addressee and a second addressee, determining that a communications device associated with the first addressee cannot receive electronic messages of the first type, generating a second electronic message based on the first message, the second electronic message of a second type, wherein the first addressee can receive electronic messages of the second type, transmitting the first electronic message to the second addressee, and transmitting the second electronic message to the first addressee.

In an aspect, a method is disclosed including responsive to receiving, by a server, a first electronic message of a first type, determining that the first electronic message contains a first addressee and a second addressee, determining, by the server, that a communications device associated with the first addressee cannot receive electronic messages of the first type, generating, by the server, a second electronic message based on the first message, the second electronic message of a second type, wherein the first addressee can receive electronic messages of the second type, transmitting, by the server, the first electronic message to the second addressee, and transmitting, by the server, the second electronic message to the first addressee.

In an aspect, computer-readable storage medium comprising executable instructions that when executed by a processor cause the processor to effectuate operations comprising: responsive to receiving a first electronic message of a first type, determining that the first electronic message contains a first addressee and a second addressee, determining that a communications device associated with the first addressee cannot receive electronic messages of the first type, generating a second electronic message based on the first message, the second electronic message of a second type, wherein the first addressee can receive electronic messages of the second type, transmitting the first electronic message to the second addressee, and transmitting the second electronic message to the first addressee.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Aspects of the herein described emergency services communication adaptation are described more fully herein with reference to the accompanying drawings, in which example embodiments are shown. In the following description, for purposes of explanation, numerous specific details are set forth in order to provide an understanding of the various embodiments. However, the instant disclosure may be embodied in many different forms and should not be construed as limited to the example embodiments set forth herein. Like numbers refer to like elements throughout.

FIG. 1 illustrates an exemplary diagram of communications in a communication adaptation system.

FIG. 2 illustrates an exemplary diagram of communications in a communication adaptation system.

FIG. 3 illustrates an exemplary flowchart for providing communication adaptation.

FIG. 4 illustrates an exemplary diagram of emergency communications in a communication adaptation system.

FIG. 5 illustrates an exemplary flowchart for emergency communications in a communication adaptation system.

FIG. 6 illustrates an exemplary diagram of communications in a communication adaptation system.

FIG. 7 is a block diagram of an example mobile device which may be utilized to facilitate communication adaptation.

FIG. 8 is a block diagram of an exemplary processor in which one or more disclosed examples may be implemented for emergency services communication adaptation.

FIG. 9 is a block diagram of an exemplary packet-based mobile cellular network environment, such as a GPRS network, in which one or more disclosed examples may be implemented for communication adaptation.

FIG. 10 illustrates a non-limiting exemplary architecture of a typical GPRS network, segmented into four groups, in which one or more disclosed examples may be implemented for communication adaptation.

FIG. 11 illustrates a non-limiting alternate block diagram of an exemplary GSM/GPRS/IP multimedia network architecture in which one or more disclosed examples may be implemented for communication adaptation.

FIG. 12 illustrates a Public Land Mobile Network (PLMN) block diagram view of an exemplary architecture in which one or more disclosed examples may be implemented for communication adaptation.

### DETAILED DESCRIPTION OF ILLUSTRATIVE EMBODIMENTS

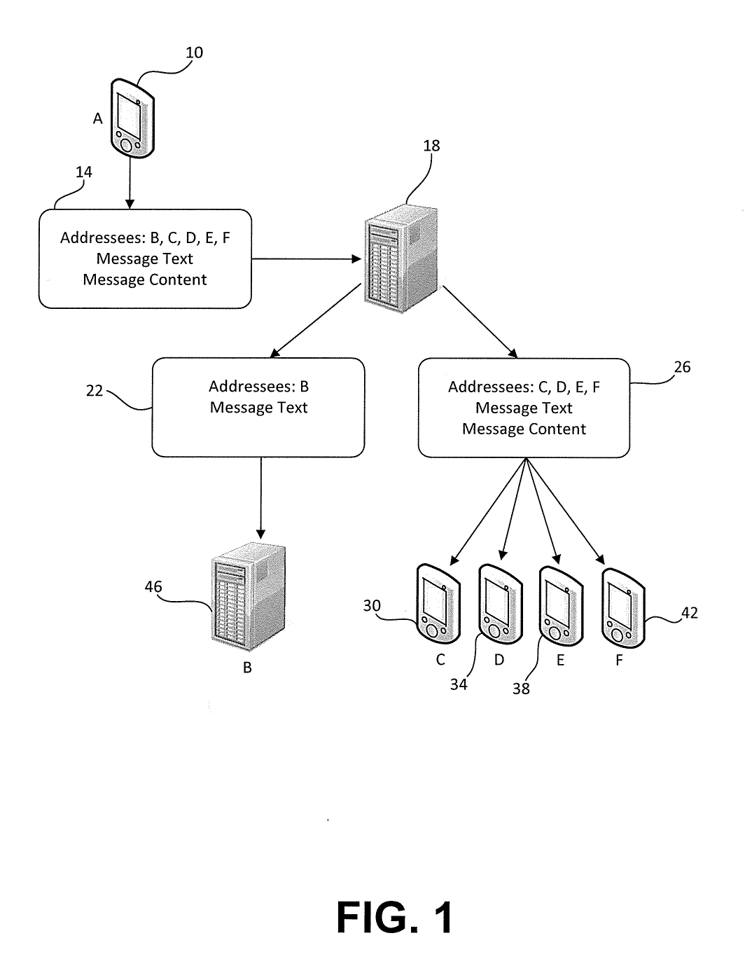

FIG. 1 illustrates an exemplary diagram of communications in a communication adaptation system. Mobile communication device 10 generates electronic message 14. Message 14 may include text and other content such as, for example, multimedia files, such as sound, image, and video files. Other content of message 14 may be, for example, additional files such as documents, messages (of the same type or different type as message 14). Message 14 as shown is addressed to addressees B, C, D, E, and F. Addressees C, D, E, and F are associated with mobile communication devices 30, 34, 38, and 42, respectively. Addressee B is associated with communications system 46. Message 14 may, en route to the addressees, pass through communication adaptation server 18. Communication adaptation server 18 may determine the addressees of message 14 by analyzing any address fields, if they exist, of message 14. Alternatively or additionally, communication adaptation server 18 may determine one or more addressees of message 14 by analyzing the message text or message content.

Communication adaptation server 18 may determine the capabilities of the equipment associated with the intended recipients of message 14. In FIG. 1, communications adaptation server 18 determines the capabilities of communications server 46 and communication devices 30, 34, 38, and 42. Communication adaptation server 18 may determine that communication devices 30, 34, 38, and 42 are capable of receiving message 14, its text, and its content. Communication adaptation server 18 may determine that communications server 46 may not be capable of receiving message 14. This may be, for example, due to lack of support for a communications protocol used by message 14 or a lack of support for the content of message 14. Lack of support for the content of message 14 may be due to a lack of support for the format of the content (such as being unable to render image files of a certain file format), lack of support for the size of the content (for example, the content may be 5 MB and only content up to 1 MB may be supported), user preferences (such as not to accept messages of a certain type or messages with content of a certain format or size), or security rules (such as not to accept or forward messages of a certain type or messages with content of a certain format or size).

As illustrated in FIG. 1, communications server 46 may not be able to fully or properly receive or process message 14. This may be, for example, because it cannot accept messages with content of the type included with message 14. Communication adaptation server 18 may make this determination, and may generate message 22 in place of message 14. Message 22 is addressed solely to addressee B and contains the message text of message 14, but the message content of message 14 has been removed. This may also involve, for example, a different message type than message 14. For example, message 14 may be an MMS message. Communications adaptation server 18 may remove the message content and convert message 14 to an SMS message and send it as message 22 to communications server 46.

Communication adaptation server 18 may make a determination that the equipment (communication devices 30, 34, 38, and 42) associated with intended recipients C, D, E, and F support message 14, including its text and content. Accordingly, communication adaptation server 18 may generate message 26, which is transmitted to communication devices 30, 34, 38, and 42. This may be, for example, a “group” communication such that the recipients are able to communicate with the rest of the “group.” The “group” may be, for example, the rest of the recipients of message 26. However, this would exclude, for example, recipients of message 22 (in this case, addressee B). Thus, responsive communications sent from communication device 30 may be addressed to D, E, F, and A.

Communication adaptation server 18 may generate a notice that it has made a determination that intended recipient B is unable or unwilling to receive message 22. Communication adaptation server 18 may include, for example, in this notice a reason (such as lack of support for the type of message sent or the message content, a security policy, or a user preference), a responsive action taken (as shown, sending message 22 to B), or a report (including such information as a summary of the communications such as, as shown, that message 14 was intended for B, C, D, E, and F but was split into message 22 to B and message 26 to C, D, E, and F). This notice may be transmitted to communication device 10 (the sender) or communication server 46 (the intended recipient for which adapting message 14 was necessary).

In one aspect, communication adaptation server 18 may make such a determination regarding the capabilities of the intended recipients of message 14 and forward message 14 to one or more appropriate network elements, such as a Multimedia Messaging Center (MMSC). For example, the MMSC may receive message 22 and message 26 from communication adaptation server 18. In this aspect, message 22 may be an SMS message and message 26 may comprise an MMS message. The MMSC may then take action on the messages, such as pushing message 22 to communication server 46 and message 26 to communication devices 30, 34, 38, and 42.

In another aspect, user A may generate message 14 using an Extensible Messaging and Presence Protocol (XMPP) application (an “Over-the-Top” or OTT messaging application) on communication device 10. Communication adaptation server 18 may determine that one or more of the intended recipient devices is unable to receive or properly interpret the XMPP message. This may be because, for example, the intended recipient cannot receive TCP communications due to a lack of support or a security feature such as a firewall. Communication adaptation server may then generate a message in a format or having elements receivable by the intended recipient. For example, communication server 46 may be unable to receive messages generated by XMPP applications transmitted using TCP. Communication adaptation server 18 may generate message 22 as, for example, an SMS message which communication server 46 may support and include in message 22 the text from message 14. Communication adaptation sever 18 may determine that communication devices 30, 34, 38, and 42 associated with intended recipients C, D, E, and F support XMPP messages transmitted using TCP and may forward message 14 accordingly as message 26 after removing B as a recipient of or participant in the communication. In one aspect, communication adaptation server 18 may then receive responsive communications from communication server 46 and forward them to communication device 10 in either the format of message 22 or the format of message 14. For example, communication server 46 may send a message responsive to message 22 as an SMS message. Communication adaptation server may then

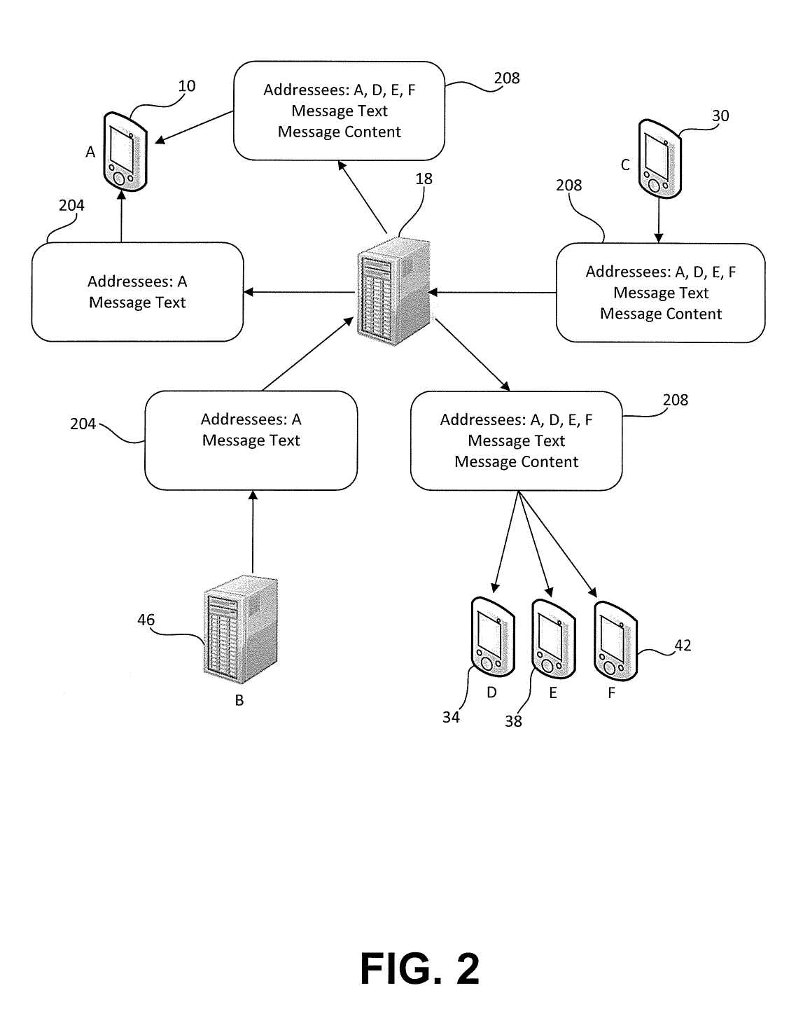

FIG. 2 illustrates an exemplary diagram of communications in a communication adaptation system. FIG. 2 illustrates system illustrated in FIG. 1 with different communications. In one aspect, FIG. 2 illustrates communications sent after the communications shown in FIG. 1. As illustrated in FIG. 2, communication server 46 may send message 204 to communication device 10 containing only message text as generated by recipient B. Recipient C may generate message 208 containing text and content. Message 204 would only be transmitted by communication adaptation server 18 to communication device 10 despite message 14 as shown in FIG. 1 being intended for a set of recipients (B, C, D, E, and F). Similarly, message 208 would be transmitted by communication adaptation server to communication devices 10, 34, 38, and 42, because message 26 as shown in FIG. 1 was transmitted to recipients C, D, E, and F.

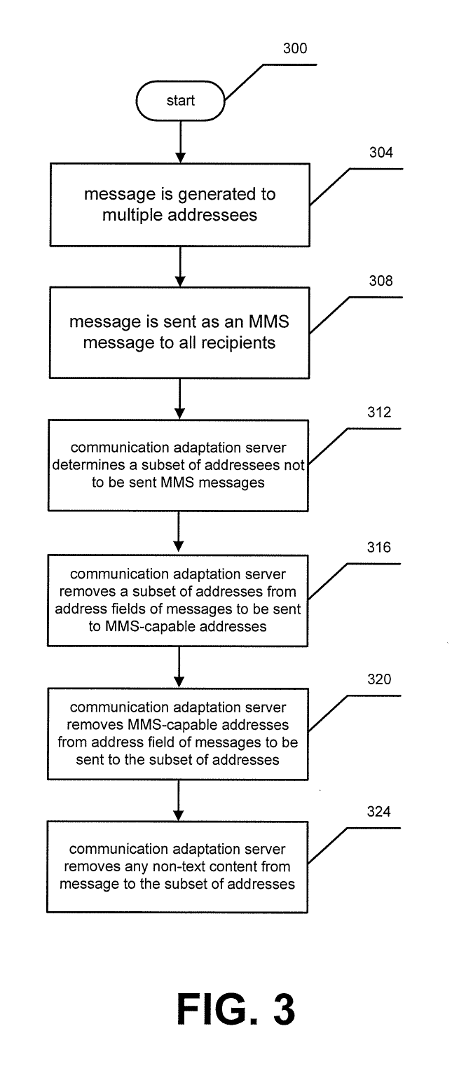

FIG. 3 illustrates an exemplary flowchart for providing communication adaptation. At 300, a user may wish to send a message using a communications device. In this exemplary illustration, the message may be an MMS message. At 304, a message having more than one intended recipient is generated using the communications device. At 308, the message is sent from the communications device as an MMS message directed to all the intended recipients. At 312, communication adaptation server 18 determines that a subset of the addressees (at least one) should not or cannot be sent MMS messages. This may be due, for example, to a lack of support for MMS messages by the subset of addressees, or for more than one reason. For example, the device associated with one intended recipient may be unable to support MMS messages, and a device associated with a different intended recipient may have an associated user preferences not to receive MMS messages. Both of these intended recipients may be in the subset.

At 316, communication adaptation server 18 removes this subset of addressees from the address fields of messages to be sent to devices associated with intended recipients which may receive MMS messages. At 320, communication adaptation server 18 removes the addresses of the non-subset addressees from the address field of messages to be sent to the previously identified subset of addressees. At 324, communication adaptation server 18 removes non-text content from the message to be sent to the previously identified subset of addressees, and accordingly generate SMS messages with the text of the original message. In this way, content adaptation server 18 may separate provide MMS communications to devices which do not support MMS by providing the communications in the form of SMS messages and still provide MMS communications to the devices supporting MMS communications.

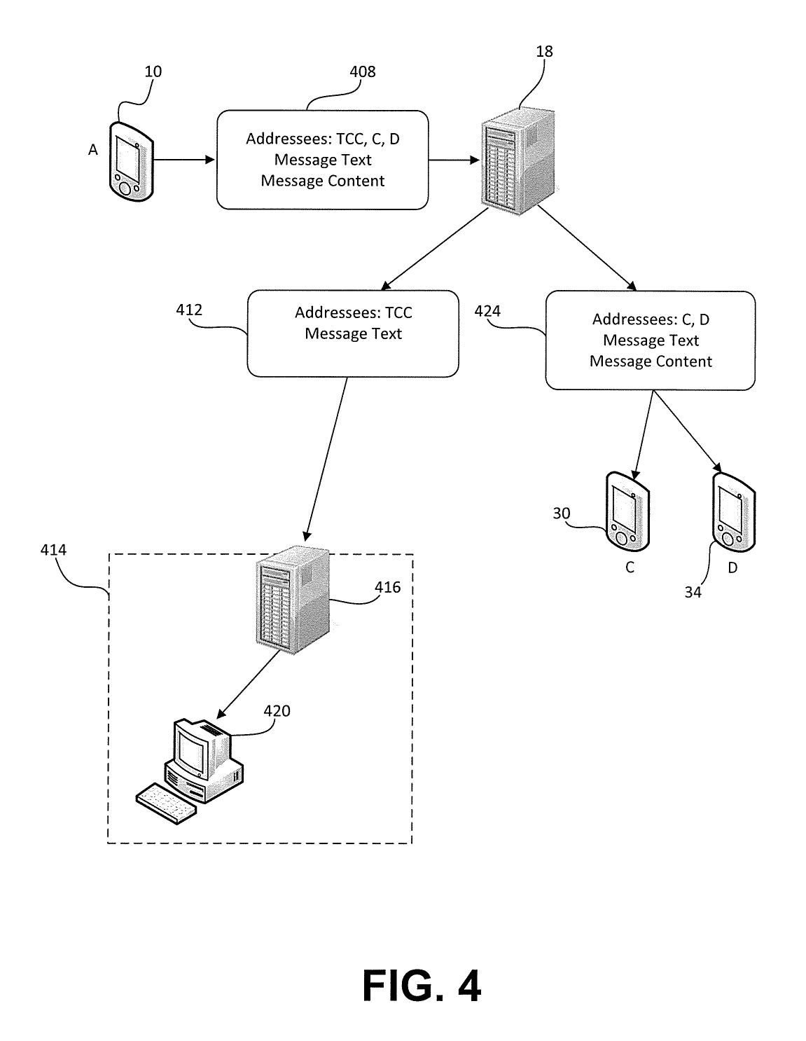

FIG. 4 illustrates an exemplary diagram of emergency communications in a communication adaptation system. Isolating the data stream from the originator of the emergency communication, in this case communications device 10, allows for emergency services to gather information more accurately and effectively. Emergency message 408 may be generated using communications device 10. Emergency message may contain text and additional content. For example, emergency message 408 may include text with details regarding the emergency. Emergency message 408 may further include content such as an image file with information regarding the emergency. For example, the image file may be a picture of an injury to an individual. Emergency message 408 may be sent to multiple addressees, in this case C, D, and 911 (a Text Control Center (TCC)).

Emergency message 408 may be of a type not supported by TCC 414. For example, message 408 may be an MMS message and TCC 414 may not support MMS communications. However, communications devices 30 and 34 for recipients C and D may support MMS communications. Accordingly, communication adaptation server 18 may generate message 412 by removing the message content and addressees C and D from message 408. Message 412 may then be transmitted to public-safety answering point (PSAP) gateway 416 as an SMS message. PSAP gateway 416 may then forward message 412 to terminal 420. Terminal 420 may be used by a emergency services user (such as a dispatcher) who may then be able to interpret the message text and associated information.

Communication adaptation server 18 may generate message 424 from message 408 by removing the TCC addressee and transmitting message 424 containing the message text and content of message 408 to communication devices 30 and 34. Responsive communications from recipients C and D may then be sent between the “group” of communication devices 10, 30, and 34, corresponding to A, C, and D, and not to TCC 414. Accordingly, TCC 414 may not receive extraneous communications which may disrupt the provision of emergency services. For example, location-based services may become confused where TCC 414 receives messages from communication device 30. If the emergency is with communication device 10, then location information for messages from communication device 30 may be entirely misleading.

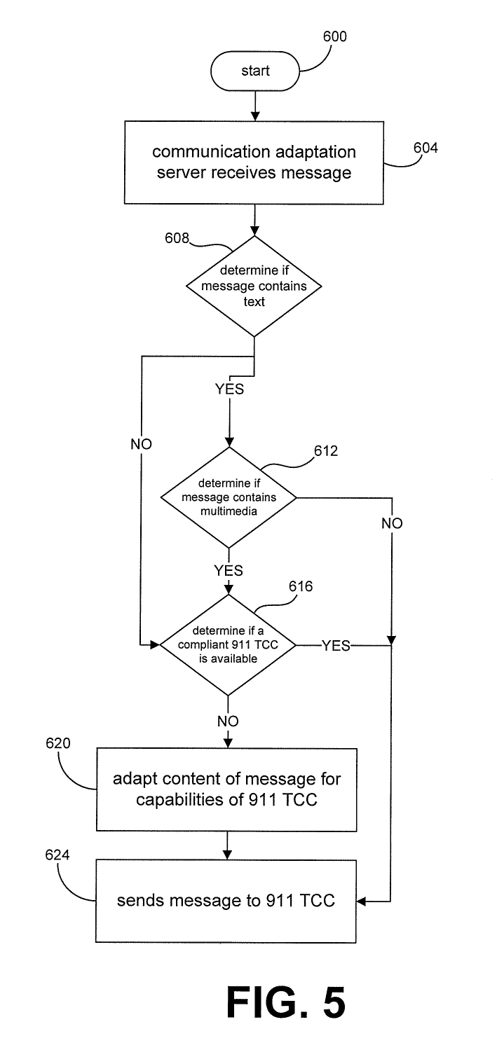

FIG. 5 illustrates an exemplary flowchart for emergency communications in a communication adaptation system. At 600, an emergency message is sent. At 604, communication adaptation server 18 receives the emergency message. At 608, communication adaptation server 18 determines if the message contains text. If not, at 616 communication adaptation server 18 determines if a compliant 911 TCC is available. A compliant 911 TCC is one that can receive MMS messages. In this case, with no text (which may mean no characters—empty spaces entered in a message may be considered characters), the message may be assumed to include additional content, such as an attached multimedia object, document, or other file. If the message does contain text, then it cannot be assumed to be an MMS message. Accordingly, communication adaptation server 18 determines if the message contains additional content, such as multimedia content. If so, at 616, it is determined by content adaptation server 18 whether a TCC capable of receiving MMS messages is available. If so, at 624, the message is transmitted to the TCC. If a compliant-TCC is not available, at 620, communication adaptation server 18 adapts the message for the capabilities of the TCC. For example, additional content may be removed from the message and the message converted to an SMS message before sending. Even in the case where a message contains no text and the additional content is removed, the message may still be useful to the TCC as it may trigger activity by emergency services to investigate and respond.

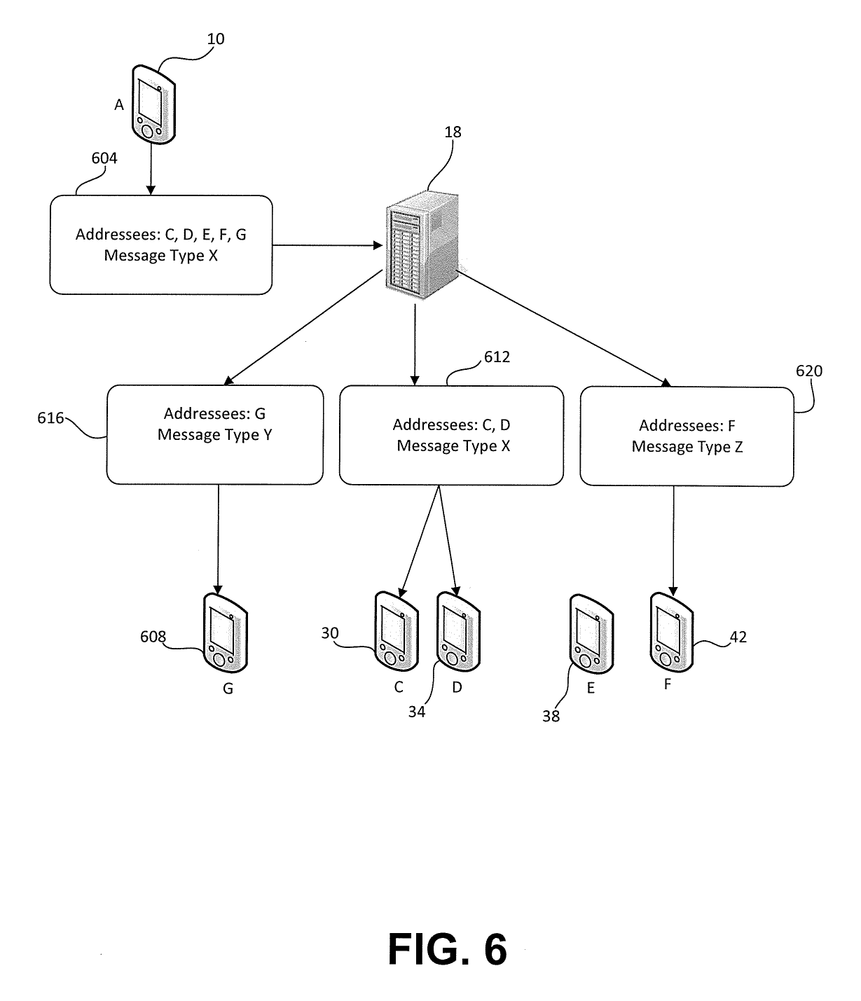

FIG. 6 illustrates an exemplary diagram of communications in a communication adaptation system. At 604, message 604 generated using communications device 10 may be sent intended for recipients C, D, E, F, and G. Communication adaptation server 18 may determine that message 604 is of a certain type (listed in FIG. 6 as “Type X”). Communication adaptation server 18 may determine that communications device 608 associated with Addressee G is unable to receive communications of Type X and may convert message 604 into message 616 which may be of a type supported by communications device 608. Similarly, communications device 42 may be unable to support messages of Type X but may support messages of Type Z, and communications adaptation server may convert message 604 into message 620 of Type Z before transmitting message 620 to communications device 42. Type Z may be chosen, for example, over Type Y for communications device 42 based on factors beyond compatibility such as user preferences and bandwidth. Message 612 may be transmitted to communication devices 30 and 34 still in the original message format (Type X) after a determination that communication devices 30 and 34 support messages of Type X.

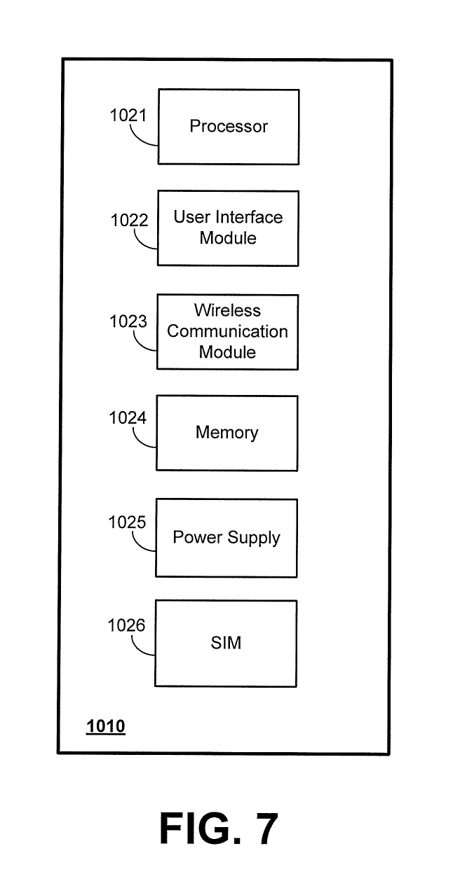

FIG. 7 illustrates an example wireless device 1010 (i.e., WTRU) that may be used in connection with an example of emergency services communication adaptation. References will also be made to other figures of the present disclosure as appropriate. For example, mobile devices, such as WTRU 556, may be wireless devices of the type described in regard to FIG. 7, and may have some, all, or none of the components and modules described in regard to FIG. 7. It will be appreciated that the components and modules of wireless device 1010 illustrated in FIG. 7 are illustrative, and that any number and type of components and/or modules may be present in wireless device 1010. In addition, the functions performed by any or all of the components and modules illustrated in FIG. 7 may be performed by any number of physical components. Thus, it is possible that in some examples the functionality of more than one component and/or module illustrated in FIG. 7 may be performed by any number or types of hardware or hardware and software.

Processor 1021 may comprise any appropriate circuitry that performs operations on behalf of wireless device 1010. Such circuitry may include hardware and other components that enable processor 1021 to perform any of the functions and methods described herein. Such circuitry and other components may also enable processor 1021 to communicate and/or interact with other devices and components, for example any other component of device of wireless device 1010, in such a manner as to enable processor 118 and such other devices and/or components to perform any of the disclosed functions and methods. In one example, processor 1021 executes software (i.e., computer readable instructions stored in a computer readable medium) that may include functionality related to emergency services communication adaptation, for example. User interface module 1022 may be any type or combination of hardware and software that enables a user to operate and interact with wireless device 1010, and, in one example, to interact with a system enabling the user to place, request, and/or receive calls, text communications of any type, voicemail, voicemail notifications, voicemail content and/or data, and/or a system. For example, user interface module 1022 may include a display, physical and/or “soft” keys, voice recognition software, a microphone, a speaker and the like. Wireless communication module 1023 may be any type of transceiver including any combination of hardware and software that enables wireless device 1010 to communicate with wireless network equipment. Memory 1024 enables wireless device 1010 to store information, such as APNs, MNCs, MCCs, text communications content and associated data, multimedia content, software to efficiently process radio resource requests and service requests, and radio resource request processing preferences and configurations. Memory 1024 may take any form, such as internal random access memory (RAM), an SD card, a microSD card and the like. Power supply 1025 may be a battery or other type of power input (e.g., a charging cable that is connected to an electrical outlet, etc.) that is capable of powering wireless device 1010. SIM 1026 may be any type Subscriber Identity Module and may be configured on a removable or non-removable SIM card that allows wireless device 1010 to store data on SIM 1026.

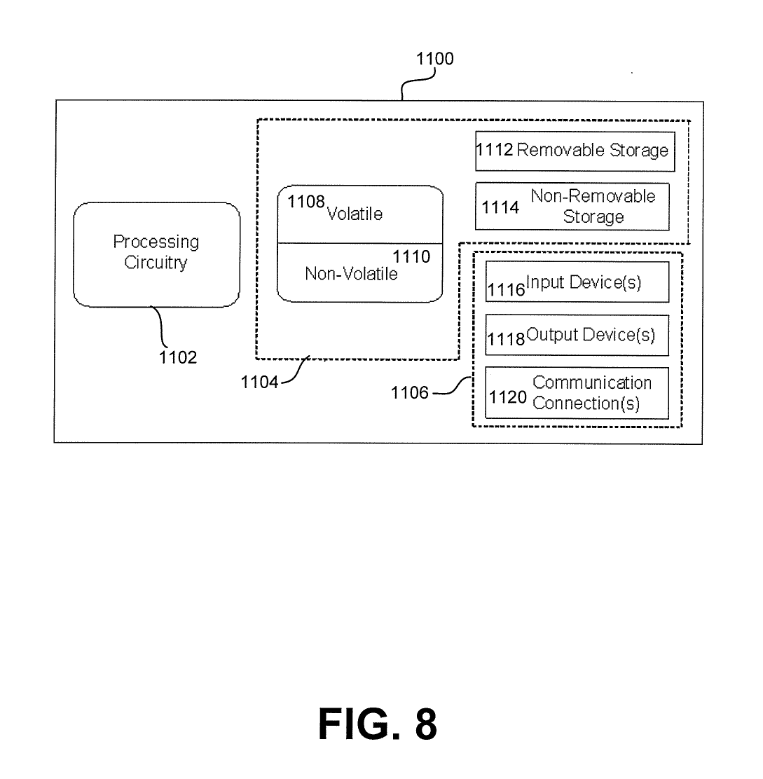

FIG. 8 is a block diagram of an example apparatus 1100 which may be employed in any of the examples described herein, including as one or more components of WTRU 556, short-range communication device 38, 40, 42, and/or 46, short-range communication tag 548, and/or any related equipment, and/or as one or more components of any third party system or subsystem that may implement any portion of the subject matter described herein. Apparatus 1100 may be a processor. It is emphasized that the block diagram depicted in FIG. 8 is exemplary and not intended to imply a specific implementation. Thus, the apparatus 1100 may be implemented in a single processor or multiple processors. Multiple processors may be distributed or centrally located. Multiple processors can communicate wirelessly, via hard wire, or a combination thereof. Apparatus 1100 may include circuitry and other components that enable apparatus 1100 to perform any of the functions and methods described herein. Such circuitry and other components may also enable apparatus 1100 to communicate and/or interact with other devices and components, for example any other component of any device disclosed herein or any other device, in such a manner as to enable apparatus 1100 and such other devices and/or components to perform any of the disclosed functions and methods.

As depicted in FIG. 8, the apparatus 1100 may comprise a processing portion 1102, a memory portion 1104, and an input/output portion 1106. The processing portion 1102, memory portion 1104, and input/output portion 1106 are coupled together (coupling not shown in FIG. 8) to allow communications between these portions. The input/output portion 1106 is capable of providing and/or receiving components, commands, and/or instructions, utilized to, for example, request and receive APNs, MNCs, and/or MCCs, establish and terminate communications sessions, transmit and receive service requests and data access request data and responses, transmit, receive, store and process text, data, and voice communications, execute software that efficiently processes radio resource requests, receive and store service requests and radio resource requests, radio resource request processing preferences and configurations, and/or perform any other function described herein.

The apparatus 1100 may be implemented as a client processor and/or a server processor. In a basic configuration, the apparatus 1100 may include at least one processing portion 1102 and memory portion 1104. The memory portion 1104 can store any information utilized in conjunction with establishing, transmitting, receiving, and/or processing text, data, and/or voice communications, communications-related data and/or content, voice calls, other telephonic communications, etc. For example, the memory portion is capable of storing APNs, MNCs, MCCs, service requests, radio resource requests, QoS and/or APN parameters, software for emergency services communication adaptation, text and data communications, calls, voicemail, multimedia content, visual voicemail applications, etc. Depending upon the exact configuration and type of processor, the memory portion 1104 can be volatile (such as RAM) 1108, non-volatile (such as ROM, flash memory, etc.) 1110, or a combination thereof. The apparatus 1100 can have additional features/functionality. For example, the apparatus 1100 may include additional storage (removable storage 1112 and/or non-removable storage 1114) including, but not limited to, magnetic or optical disks, tape, flash, smart cards or a combination thereof. Computer storage media, such as memory and storage elements 1104, 1108, 1110, 1112, and 1114, may include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium that can be used to store the desired information and that can be accessed by the apparatus 1100. Any such computer storage media may be part of the apparatus 1100.

The apparatus 1100 may also contain the communications connection(s) 1120 that allow the apparatus 1100 to communicate with other devices, for example through a radio access network (RAN). Communications connection(s) 1120 is an example of communication media. Communication media typically embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection as might be used with a land line telephone, and wireless media such as acoustic, RF, infrared, cellular, and other wireless media. The term computer-readable media as used herein includes both storage media and communication media. The apparatus 1100 also can have input device(s) 1116 such as keyboard, keypad, mouse, pen, voice input device, touch input device, etc. Output device(s) 1118 such as a display, speakers, printer, etc., also can be included.

A RAN as described herein may comprise any telephony radio network, or any other type of communications network, wireline or wireless, or any combination thereof. The following description sets forth some exemplary telephony radio networks, such as the global system for mobile communications (GSM), and non-limiting operating environments. The below-described operating environments should be considered non-exhaustive, however, and thus the below-described network architectures merely show how emergency services communication adaptation may be implemented with stationary and non-stationary network structures and architectures in order to do emergency services communication adaptation. It can be appreciated, however, that emergency services communication adaptation as described herein may be incorporated with existing and/or future alternative architectures for communication networks as well.

The GSM is one of the most widely utilized wireless access systems in today's fast growing communication environment. The GSM provides circuit-switched data services to subscribers, such as mobile telephone or computer users. The General Packet Radio Service (GPRS), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

The exemplary GSM/GPRS environment and services described herein also may be extended to 3G services, such as Universal Mobile Telephone System (UMTS), Frequency Division Duplexing (FDD) and Time Division Duplexing (TDD), High Speed Packet Data Access (HSPDA), cdma2000 1 Evolution Data Optimized (EVDO), Code Division Multiple Access-2000 (cdma2000 3), Time Division Synchronous Code Division Multiple Access (TD-SCDMA), Wideband Code Division Multiple Access (WCDMA), Enhanced Data GSM Environment (EDGE), International Mobile Telecommunications-2000 (IMT-2000), Digital Enhanced Cordless Telecommunications (DECT), 4G Services such as Long Term Evolution (LTE), etc., as well as to other network services that become available in time. In this regard, emergency services communication adaptation may be applied independently of the method of data transport and does not depend on any particular network architecture or underlying protocols.

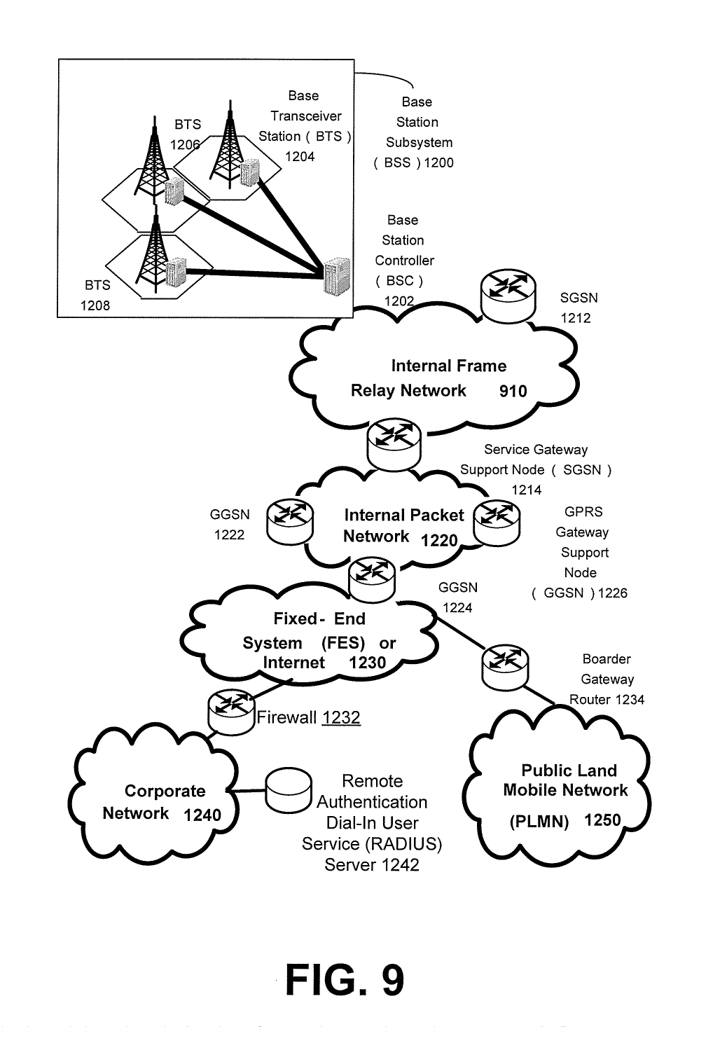

FIG. 9 depicts an overall block diagram of an example packet-based mobile cellular network environment, such as a GPRS network, that may be utilized to facilitate intelligent traffic routing, as described herein. In the example packet-based mobile cellular network environment shown in FIG. 9, there are a plurality of Base Station Subsystems (“BSS”) 1200 (only one is shown), each of which comprises a Base Station Controller (“BSC”) 1202 serving a plurality of Base Transceiver Stations (“BTS”) such as BTSs 1204, 1206, and 1208. BTSs 1204, 1206, 1208, etc. are the access points where users of packet-based mobile devices become connected to the wireless network. In example fashion, the packet traffic originating from user devices is transported via an over-the-air interface to a BTS 1208, and from the BTS 1208 to the BSC 1202. Base station subsystems, such as BSS 1200, are a part of internal frame relay network 1210 that can include Service GPRS Support Nodes (“SGSN”) such as SGSN 1212 and 1214. Each SGSN is connected to an internal packet network 820 through which a SGSN 1212, 1214, etc., can route data packets to and from a plurality of gateway GPRS support nodes (GGSN) 1222, 1224, 1226, etc. As illustrated, SGSN 1214 and GGSNs 1222, 1224, and 1226 are part of internal packet network 1220. Gateway GPRS serving nodes 1222, 1224 and 1226 mainly provide an interface to external Internet Protocol (“IP”) networks such as Public Land Mobile Network (“PLMN”) 1250, corporate intranets 1240, or Fixed-End System (“FES”) or the public Internet 1230. As illustrated, subscriber corporate network 1240 may be connected to GGSN 1224 via firewall 1232; and PLMN 1250 is connected to GGSN 1224 via boarder gateway router 1234. The Remote Authentication Dial-In User Service (“RADIUS”) server 1242 may be used for caller authentication when a user of a mobile cellular device calls corporate network 1240.

Generally, there may be a several cell sizes in a GSM network, referred to as macro, micro, pico, femto and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. Femto cells have the same size as pico cells, but a smaller transport capacity. Femto cells are used indoors, in residential, or small business environments. On the other hand, umbrella cells are used to cover shadowed regions of smaller cells and fill in gaps in coverage between those cells.

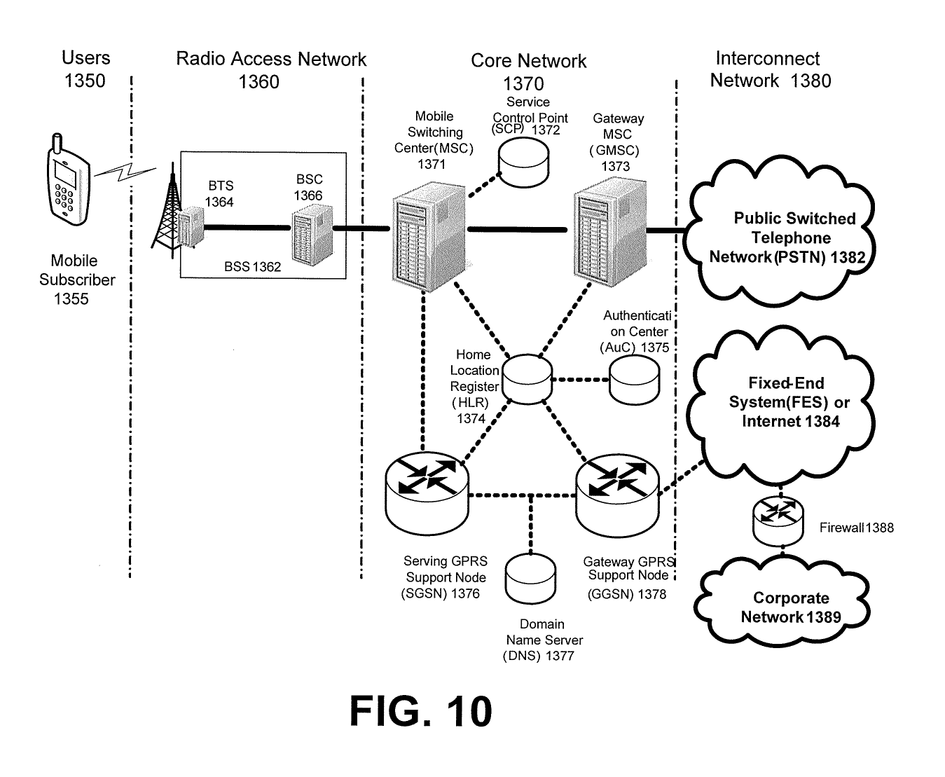

FIG. 10 illustrates an architecture of a typical GPRS network that may be utilized to facilitate intelligent traffic routing, as described herein. The architecture depicted in FIG. 10 may be segmented into four groups: users 1350, radio access network 1360, core network 1370, and interconnect network 1380. Users 1350 comprise a plurality of end users. Note, WTRU 556 is referred to as a mobile subscriber in the description of network shown in FIG. 10. In an aspect, the device depicted as mobile subscriber 1355 comprises a communications device (e.g., communications device 160). Radio access network 1360 comprises a plurality of base station subsystems such as BSSs 1362, which include BTSs 1364 and BSCs 1366. Core network 1370 comprises a host of various network elements. As illustrated in FIG. 10, core network 1370 may comprise Mobile Switching Center (“MSC”) 1371, Service Control Point (“SCP”) 1372, gateway MSC 1373, SGSN 1376, Home Location Register (“HLR”) 1374, Authentication Center (“AuC”) 1375, Domain Name Server (“DNS”) 1377, and GGSN 1378. Interconnect network 1380 also comprises a host of various networks and other network elements. As illustrated in FIG. 10, interconnect network 1380 comprises Public Switched Telephone Network (“PSTN”) 1382, Fixed-End System (“FES”) or Internet 984, firewall 1388, and Corporate Network 1389.

A mobile switching center can be connected to a large number of base station controllers. At MSC 1371, for instance, depending on the type of traffic, the traffic may be separated in that voice may be sent to Public Switched Telephone Network (“PSTN”) 1382 through Gateway MSC (“GMSC”) 1373, and/or data may be sent to SGSN 1376, which then sends the data traffic to GGSN 1378 for further forwarding.

When MSC 1371 receives call traffic, for example, from BSC 1366, it sends a query to a database hosted by SCP 1372. The SCP 1372 processes the request and issues a response to MSC 971 so that it may continue call processing as appropriate.

The HLR 1374 is a centralized database for users to register to the GPRS network. HLR 1374 stores static information about the subscribers such as the International Mobile Subscriber Identity (“IMSI”), subscribed services, and a key for authenticating the subscriber. HLR 1374 also stores dynamic subscriber information such as the current location of the mobile subscriber. Associated with HLR 1374 is AuC 1375. AuC 1375 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device (such as WTRU 556), used by an end user of the mobile cellular service. When a mobile subscriber turns on his or her mobile device, the mobile device goes through an attach process by which the mobile device attaches to an SGSN of the GPRS network. In FIG. 10, when mobile subscriber 1355 initiates the attach process by turning on the network capabilities of the mobile device, an attach request is sent by mobile subscriber 1355 to SGSN 1376. The SGSN 1376 queries another SGSN, to which mobile subscriber 912 was attached before, for the identity of mobile subscriber 1355. Upon receiving the identity of mobile subscriber 1355 from the other SGSN, SGSN 1376 requests more information from mobile subscriber 1355. This information is used to authenticate mobile subscriber 1355 to SGSN 1376 by HLR 1374. Once verified, SGSN 1376 sends a location update to HLR 1374 indicating the change of location to a new SGSN, in this case SGSN 1376. HLR 1374 notifies the old SGSN, to which mobile subscriber 1355 was attached before, to cancel the location process for mobile subscriber 1355. HLR 1374 then notifies SGSN 1376 that the location update has been performed. At this time, SGSN 1376 sends an Attach Accept message to mobile subscriber 1355, which in turn sends an Attach Complete message to SGSN 1376.

After attaching itself with the network, mobile subscriber 1355 then goes through the authentication process. In the authentication process, SGSN 1376 sends the authentication information to HLR 1374, which sends information back to SGSN 1376 based on the user profile that was part of the user's initial setup. The SGSN 1376 then sends a request for authentication and ciphering to mobile subscriber 912. The mobile subscriber 1355 uses an algorithm to send the user identification (ID) and password to SGSN 1376. The SGSN 1376 uses the same algorithm and compares the result. If a match occurs, SGSN 1376 authenticates mobile subscriber 1355.

Next, the mobile subscriber 1355 establishes a user session with the destination network, corporate network 1389, by going through a Packet Data Protocol (“PDP”) activation process. Briefly, in the process, mobile subscriber 1355 requests access to the Access Point Name (“APN”), for example, UPS.com, and SGSN 1376 receives the activation request from mobile subscriber 1355. SGSN 1376 then initiates a Domain Name Service (“DNS”) query to learn which GGSN node has access to the UPS.com APN. The DNS query is sent to the DNS server within the core network 1370, such as DNS 1377, which is provisioned to map to one or more GGSN nodes in the core network 1370. Based on the APN, the mapped GGSN 1378 can access the requested corporate network 1389. The SGSN 1376 then sends to GGSN 1378 a Create Packet Data Protocol (“PDP”) Context Request message that contains necessary information. The GGSN 1378 sends a Create PDP Context Response message to SGSN 1376, which then sends an Activate PDP Context Accept message to mobile subscriber 1355.

Once activated, data packets of the call made by mobile subscriber 1355 can then go through radio access network 1360, core network 1370, and interconnect network 1380, in a particular fixed-end system or Internet 1384 and firewall 1388, to reach corporate network 1389.

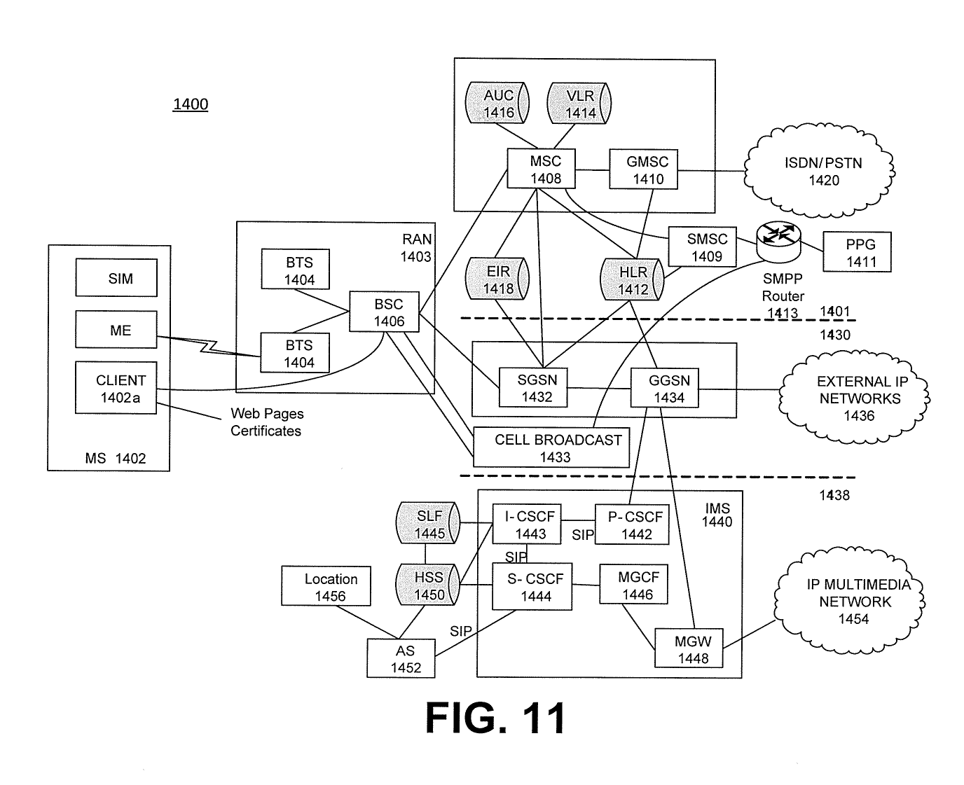

FIG. 11 illustrates an example block diagram view of a GSM/GPRS/IP multimedia network architecture that may be utilized to facilitate intelligent traffic routing, as described herein. As illustrated, the architecture of FIG. 11 includes a GSM core network 1400, a GPRS network 1430 and an IP multimedia network 1438. The GSM core network 1401 includes a Mobile Station (MS) 1402, at least one Base Transceiver Station (BTS) 1404 and a Base Station Controller (BSC) 1406. The MS 1402 is physical equipment or Mobile Equipment (ME), such as a mobile phone or a laptop computer that is used by mobile subscribers, with a Subscriber identity Module (SIM) or a Universal Integrated Circuit Card (UICC). The SIM or UICC includes an International Mobile Subscriber Identity (IMSI), which is a unique identifier of a subscriber. The BTS 1404 is physical equipment, such as a radio tower, that enables a radio interface to communicate with the MS. Each BTS may serve more than one MS. The BSC 1406 manages radio resources, including the BTS. The BSC may be connected to several BTSs. The BSC and BTS components, in combination, are generally referred to as a base station (BSS) or radio access network (RAN) 1403.

The GSM core network 1401 also includes a Mobile Switching Center (MSC) 1008, a Gateway Mobile Switching Center (GMSC) 1410, a Home Location Register (HLR) 1412, Visitor Location Register (VLR) 1414, an Authentication Center (AuC) 1418, and an Equipment Identity Register (EIR) 1416. The MSC 1408 performs a switching function for the network. The MSC also performs other functions, such as registration, authentication, location updating, handovers, and call routing. The GMSC 1410 provides a gateway between the GSM network and other networks, such as an Integrated Services Digital Network (ISDN) or Public Switched Telephone Networks (PSTNs) 1420. Thus, the GMSC 1410 provides interworking functionality with external networks.

The HLR 1412 is a database that contains administrative information regarding each subscriber registered in a corresponding GSM network. The HLR 1412 also contains the current location of each MS. The VLR 1414 is a database that contains selected administrative information from the HLR 1412. The VLR contains information necessary for call control and provision of subscribed services for each MS currently located in a geographical area controlled by the VLR. The HLR 1412 and the VLR 1414, together with the MSC 1408, provide the call routing and roaming capabilities of GSM. The AuC 1416 provides the parameters needed for authentication and encryption functions. Such parameters allow verification of a subscriber's identity. The EIR 1418 stores security-sensitive information about the mobile equipment.

A Short Message Service Center (SMSC) 1409 allows one-to-one Short Message Service (SMS) messages to be sent to/from the MS 1402. A Push Proxy Gateway (PPG) 1411 is used to “push” (i.e., send without a synchronous request) content to the MS 1002. The PPG 1411 acts as a proxy between wired and wireless networks to facilitate pushing of data to the MS 1402. A Short Message Peer to Peer (SMPP) protocol router 1413 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1402 sends a location update including its current location information to the MSC/VLR, via the BTS 1404 and the BSC 1406. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1430 is logically implemented on the GSM core network architecture by introducing two packet-switching network nodes, a serving GPRS support node (SGSN) 1432, a cell broadcast and a Gateway GPRS support node (GGSN) 1434. The SGSN 1432 is at the same hierarchical level as the MSC 1408 in the GSM network. The SGSN controls the connection between the GPRS network and the MS 1402. The SGSN also keeps track of individual MS's locations and security functions and access controls.

A Cell Broadcast Center (CBC) 1433 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1434 provides a gateway between the GPRS network and a public packet network (PDN) or other IP networks 1436. That is, the GGSN provides interworking functionality with external networks, and sets up a logical link to the MS through the SGSN. When packet-switched data leaves the GPRS network, it is transferred to an external TCP-IP network 1436, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1430 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while received data and vice versa.

The IP multimedia network 1438 was introduced with 3GPP Release 5, and includes an IP multimedia subsystem (IMS) 1440 to provide rich multimedia services to end users. A representative set of the network entities within the IMS 1440 are a call/session control function (CSCF), a media gateway control function (MGCF) 1446, a media gateway (MGW) 1448, and a master subscriber database, called a home subscriber server (HSS) 1450. The HSS 1450 may be common to the GSM network 1401, the GPRS network 1430 as well as the IP multimedia network 1438.

The IP multimedia system 1440 is built around the call/session control function, of which there are three types: an interrogating CSCF (I-CSCF) 1043, a proxy CSCF (P-CSCF) 1042, and a serving CSCF (S-CSCF) 1444. The P-CSCF 1042 is the MS's first point of contact with the IMS 1440. The P-CSCF 1442 forwards session initiation protocol (SIP) messages received from the MS to an SIP server in a home network (and vice versa) of the MS. The P-CSCF 1442 may also modify an outgoing request according to a set of rules defined by the network operator (for example, address analysis and potential modification).

The I-CSCF 1443, forms an entrance to a home network and hides the inner topology of the home network from other networks and provides flexibility for selecting an S-CSCF. The I-CSCF 1443 may contact a subscriber location function (SLF) 1445 to determine which HSS 1450 to use for the particular subscriber, if multiple HSS's 1450 are present. The S-CSCF 1444 performs the session control services for the MS 1402. This includes routing originating sessions to external networks and routing terminating sessions to visited networks. The S-CSCF 1444 also decides whether an application server (AS) 1452 is required to receive information on an incoming SIP session request to ensure appropriate service handling. This decision is based on information received from the HSS 1450 (or other sources, such as an application server 1452). The AS 1452 also communicates to a location server 1456 (e.g., a Gateway Mobile Location Center (GMLC)) that provides a position (e.g., latitude/longitude coordinates) of the MS 1402.

The HSS 1450 contains a subscriber profile and keeps track of which core network node is currently handling the subscriber. It also supports subscriber authentication and authorization functions (AAA). In networks with more than one HSS 1450, a subscriber location function provides information on the HSS 1450 that contains the profile of a given subscriber.

The MGCF 1446 provides interworking functionality between SIP session control signaling from the IMS 1440 and ISUP/BICC call control signaling from the external GSTN networks (not shown). It also controls the media gateway (MGW) 1448 that provides user-plane interworking functionality (e.g., converting between AMR- and PCM-coded voice). The MGW 1448 also communicates with other IP multimedia networks 1454.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

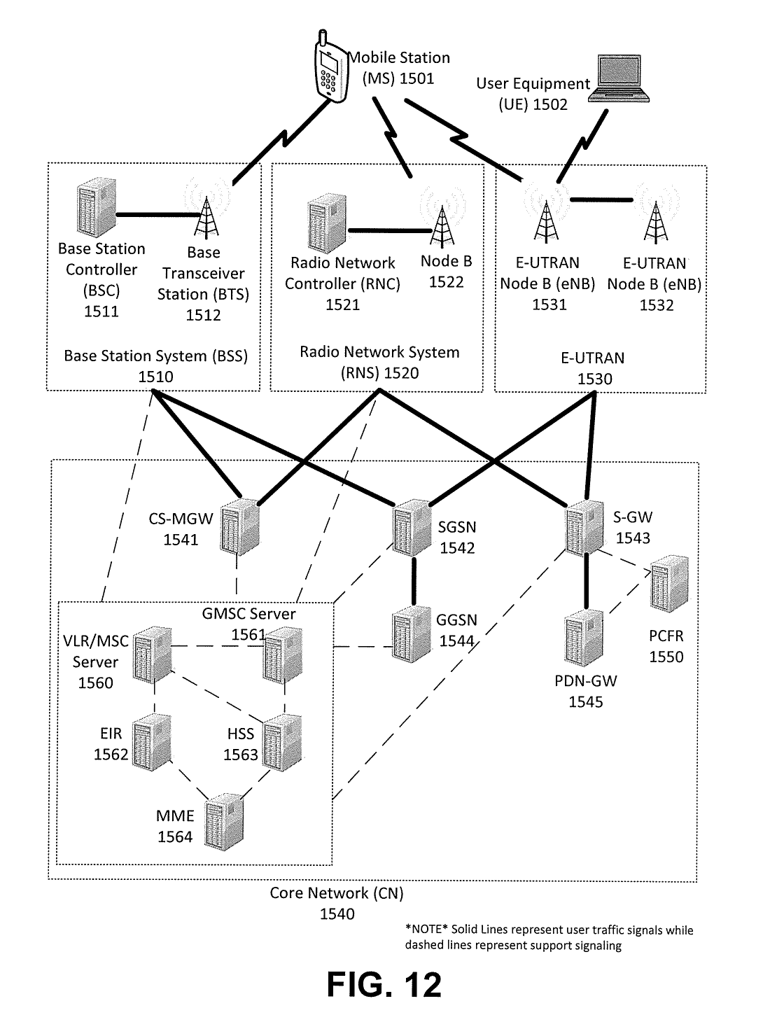

FIG. 12 illustrates a PLMN block diagram view of an exemplary architecture in which emergency services communication adaptation may be incorporated. Mobile Station (MS) 1501 is the physical equipment used by the PLMN subscriber. In one illustrative example, communications device 40 may serve as Mobile Station 1501. Mobile Station 1501 may be one of, but not limited to, a cellular telephone, a cellular telephone in combination with another electronic device or any other wireless mobile communication device.

Mobile Station 1501 may communicate wirelessly with Base Station System (BSS) 1510. BSS 1510 contains a Base Station Controller (BSC) 1511 and a Base Transceiver Station (BTS) 1512. BSS 1510 may include a single BSC 1511/BTS 1512 pair (Base Station) or a system of BSC/BTS pairs which are part of a larger network. BSS 1510 is responsible for communicating with Mobile Station 1501 and may support one or more cells. BSS 1510 is responsible for handling cellular traffic and signaling between Mobile Station 1501 and Core Network 1540. Typically, BSS 1510 performs functions that include, but are not limited to, digital conversion of speech channels, allocation of channels to mobile devices, paging, and transmission/reception of cellular signals.

Additionally, Mobile Station 1501 may communicate wirelessly with Radio Network System (RNS) 1520. RNS 1520 contains a Radio Network Controller (RNC) 1521 and one or more Node(s) B 1322. RNS 1320 may support one or more cells. RNS 1520 may also include one or more RNC 1521/Node B 1522 pairs or alternatively a single RNC 1521 may manage multiple Nodes B 1522. RNS 1520 is responsible for communicating with Mobile Station 1501 in its geographically defined area. RNC 1521 is responsible for controlling the Node(s) B 1522 that are connected to it and is a control element in a UMTS radio access network. RNC 1521 performs functions such as, but not limited to, load control, packet scheduling, handover control, security functions, as well as controlling Mobile Station 1501's access to the Core Network (CN) 1540.

The evolved UMTS Terrestrial Radio Access Network (E-UTRAN) 1530 is a radio access network that provides wireless data communications for Mobile Station 1501 and User Equipment 1502. E-UTRAN 1530 provides higher data rates than traditional UMTS. It is part of the Long Term Evolution (LTE) upgrade for mobile networks and later releases meet the requirements of the International Mobile Telecommunications (IMT) Advanced and are commonly known as a 4G networks. E-UTRAN 1530 may include of series of logical network components such as E-UTRAN Node B (eNB) 1531 and E-UTRAN Node B (eNB) 1532. E-UTRAN 1530 may contain one or more eNBs. User Equipment 1502 may be any user device capable of connecting to E-UTRAN 1530 including, but not limited to, a personal computer, laptop, mobile device, wireless router, or other device capable of wireless connectivity to E-UTRAN 1530. The improved performance of the E-UTRAN 1530 relative to a typical UMTS network allows for increased bandwidth, spectral efficiency, and functionality including, but not limited to, voice, high-speed applications, large data transfer and IPTV, while still allowing for full mobility.

An exemplary mobile data and communication service that may be implemented in the PLMN architecture described in FIG. 12 is the Enhanced Data rates for GSM Evolution (EDGE). EDGE is an enhancement for GPRS networks that implements an improved signal modulation scheme known as 9-PSK (Phase Shift Keying). By increasing network utilization, EDGE may achieve up to three times faster data rates as compared to a typical GPRS network. EDGE may be implemented on any GSM network capable of hosting a GPRS network, making it an ideal upgrade over GPRS since it may provide increased functionality of existing network resources. Evolved EDGE networks are becoming standardized in later releases of the radio telecommunication standards, which provide for even greater efficiency and peak data rates of up to 1 Mbit/s, while still allowing implementation on existing GPRS-capable network infrastructure.

Typically Mobile Station 1501 may communicate with any or all of BSS 1510, RNS 1520, or E-UTRAN 1530. In an illustrative system, each of BSS 1510, RNS 1520, and E-UTRAN 1530 may provide Mobile Station 1501 with access to Core Network 1540. The Core Network 1540 may include of a series of devices that route data and communications between end users. Core Network 1540 may provide network service functions to users in the Circuit Switched (CS) domain, the Packet Switched (PS) domain or both. The CS domain refers to connections in which dedicated network resources are allocated at the time of connection establishment and then released when the connection is terminated. The PS domain refers to communications and data transfers that make use of autonomous groupings of bits called packets. Each packet may be routed, manipulated, processed or handled independently of all other packets in the PS domain and does not require dedicated network resources.

The Circuit Switched-Media Gateway Function (CS-MGW) 1541 is part of Core Network 1540, and interacts with Visitor Location Register (VLR) and Mobile-Services Switching Center (MSC) Server 1560 and Gateway MSC Server 1561 in order to facilitate Core Network 1540 resource control in the CS domain. Functions of CS-MGW 1541 include, but are not limited to, media conversion, bearer control, payload processing and other mobile network processing such as handover or anchoring. CS-MGW 1540 may receive connections to Mobile Station 1501 through BSS 1510, RNS 1520 or both.

Serving GPRS Support Node (SGSN) 1542 stores subscriber data regarding Mobile Station 1501 in order to facilitate network functionality. SGSN 1542 may store subscription information such as, but not limited to, the International Mobile Subscriber Identity (IMSI), temporary identities, or Packet Data Protocol (PDP) addresses. SGSN 1542 may also store location information such as, but not limited to, the Gateway GPRS Support Node (GGSN) 1544 address for each GGSN where an active PDP exists. GGSN 1544 may implement a location register function to store subscriber data it receives from SGSN 1542 such as subscription or location information.

Serving Gateway (S-GW) 1543 is an interface which provides connectivity between E-UTRAN 1530 and Core Network 1540. Functions of S-GW 1543 include, but are not limited to, packet routing, packet forwarding, transport level packet processing, event reporting to Policy and Charging Rules Function (PCRF) 1550, and mobility anchoring for inter-network mobility. PCRF 1550 uses information gathered from S-GW 1543, as well as other sources, to make applicable policy and charging decisions related to data flows, network resources and other network administration functions. Packet Data Network Gateway (PDN-GW) 1545 may provide user-to-services connectivity functionality including, but not limited to, network-wide mobility anchoring, bearer session anchoring and control, and IP address allocation for PS domain connections.

Home Subscriber Server (HSS) 1563 is a database for user information, and stores subscription data regarding Mobile Station 1501 or User Equipment 1502 for handling calls or data sessions. Networks may contain one HSS 1563 or more if additional resources are required. Exemplary data stored by HSS 1563 include, but is not limited to, user identification, numbering and addressing information, security information, or location information. HSS 1563 may also provide call or session establishment procedures in both the PS and CS domains.

The VLR/MSC Server 1560 provides user location functionality. When Mobile Station 1301 enters a new network location, it begins a registration procedure. A MSC Server for that location transfers the location information to the VLR for the area. A VLR and MSC Server may be located in the same computing environment, as is shown by VLR/MSC Server 1560, or alternatively may be located in separate computing environments. A VLR may contain, but is not limited to, user information such as the IMSI, the Temporary Mobile Station Identity (TMSI), the Local Mobile Station Identity (LMSI), the last known location of the mobile station, or the SGSN where the mobile station was previously registered. The MSC server may contain information such as, but not limited to, procedures for Mobile Station 1501 registration or procedures for handover of Mobile Station 1501 to a different section of the Core Network 1540. GMSC Server 1561 may serve as a connection to alternate GMSC Servers for other mobile stations in larger networks.

Equipment Identity Register (EIR) 1562 is a logical element which may store the International Mobile Equipment Identities (IMEI) for Mobile Station 1501. In a typical example, user equipment may be classified as either “white listed” or “black listed” depending on its status in the network. In one example, if Mobile Station 1501 is stolen and put to use by an unauthorized user, it may be registered as “black listed” in EIR 1562, preventing its use on the network. Mobility Management Entity (MME) 1564 is a control node which may track Mobile Station 1501 or User Equipment 1502 if the devices are idle. Additional functionality may include the ability of MME 1564 to contact an idle Mobile Station 1501 or User Equipment 1502 if retransmission of a previous session is required.

While example embodiments of emergency services communication adaptation have been described in connection with various computing devices/processors, the underlying concepts may be applied to any computing device, processor, or system capable of facilitating intelligent traffic routing. The various techniques described herein may be implemented in connection with hardware or software or, where appropriate, with a combination of both. Thus, the methods and apparatuses of emergency services communication adaptation, or certain aspects or portions thereof, may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes an apparatus for intelligent traffic routing, on user equipment as described herein. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses associated with as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for implementing intelligent traffic routing as described herein. When implemented on a general-purpose processor, the program code combines with the processor to provide a unique apparatus that operates to invoke the functionality of intelligent traffic routing as described herein.

While emergency services communication adaptation has been described in connection with the various embodiments of the various figures, it is to be understood that other similar embodiments may be used or modifications and additions may be made to the described embodiments of emergency services communication adaptation without deviating therefrom. For example, one skilled in the art will recognize emergency services communication adaptation as described in the instant application may apply to any environment, whether wired or wireless, and may be applied to any number of such devices connected via a communications network and interacting across the network. Therefore, emergency services communication adaptation as described herein should not be limited to any single embodiment, but rather should be construed in breadth and scope in accordance with the appended claims.

What is claimed:

1. An apparatus comprising:
a processor; and
memory coupled to the processor, the memory comprising executable instructions that when executed by the processor cause the processor to effectuate operations comprising:
responsive to receiving an electronic message of a first type, determining that the electronic message contains an addressee;
determining that a communication device associated with the addressee cannot receive electronic messages of the first type;
converting the electronic message to a second type, wherein the addressee can receive electronic messages of the second type; and
transmitting the electronic message to the addressee.

2. The apparatus of claim 1, wherein the operations further comprise:
responsive to receiving the electronic message of the first type, determining that the electronic message contains a second addressee;
determining that a second communication device associated with the second addressee can receive electronic messages of the first type; and
transmitting the electronic message of the first type to the second addressee.

3. The apparatus of claim 2, wherein the operations further comprise:
removing, prior to transmitting the electronic message of the second type to the addressee, the second addressee from the electronic message; and
removing, prior to transmitting the electronic message of the first type to the second addressee, the addressee from the electronic message;

4. The apparatus of claim 2, wherein the operations further comprise:
responsive to receiving the electronic message of the first type, determining that the electronic message contains a third addressee;
determining that a third communication device associated with the third addressee can receive electronic messages of the first type;
transmitting the electronic message of the first type to the third addressee; and
responsive to receiving a response message from the third addressee, transmitting the response message to a sender of the electronic message and the second addressee.

5. The apparatus of claim 4, wherein the operations further comprise:
responsive to receiving a second response message from the addressee, transmitting the second response message to the sender of the electronic message.

6. The apparatus of claim 1, wherein the first type is MMS and the second type is SMS.

7. The apparatus of claim 1, wherein the addressee comprises a Text Control Center.

8. A method comprising:
responsive to receiving, by a server, an electronic message of a first type, determining that the electronic message contains an addressee;
determining, by the server, that a communication device associated with the addressee cannot receive electronic messages of the first type;
generating, by the server, a second electronic message based on the first message, the second electronic message of a second type, wherein the first addressee can receive electronic messages of the second type;
transmitting, by the server, the first electronic message to the second addressee; and
transmitting, by the server, the second electronic message to the first addressee.

9. The method of claim 8, further comprising:
responsive to receiving, by the server, the electronic message of the first type, determining that the electronic message contains a second addressee;
determining, by the server, that a second communication device associated with the second addressee can receive electronic messages of the first type; and
transmitting, by the server, the electronic message of the first type to the second addressee.

10. The method of claim 9, further comprising:
removing, by the server, prior to transmitting the electronic message of the second type to the addressee, the second addressee from the electronic message; and
removing, prior to transmitting the electronic message of the first type to the second addressee, the addressee from the electronic message;

11. The method of claim 9, further comprising:
responsive to receiving, by the server, the electronic message of the first type, determining, by the server, that the electronic message contains a third addressee;
determining, by the server, that a third communication device associated with the third addressee can receive electronic messages of the first type;
transmitting, by the server, the electronic message of the first type to the third addressee; and
responsive to receiving, by the server, a response message from the third addressee, transmitting, by the server, the response message to a sender of the electronic message and the second addressee.

12. The method of claim 11, further comprising:
responsive to receiving, by the server, a second response message from the addressee, transmitting, by the server, the second response message to the sender of the electronic message.

13. The method of claim 12, wherein the first type is MMS and the second type is SMS.

14. The method of claim 13, wherein the addressee comprises a Text Control Center

15. A computer-readable storage medium comprising executable instructions that when executed by a processor cause the processor to effectuate operations comprising:
responsive to receiving an electronic message of a first type, determining that the electronic message contains an addressee;
determining that a communication device associated with the addressee cannot receive electronic messages of the first type;
converting the electronic message to a second type, wherein the addressee can receive electronic messages of the second type; and
transmitting the electronic message to the addressee.

16. The computer-readable storage medium of claim 15, wherein the operations further comprise:
responsive to receiving the electronic message of the first type, determining that the electronic message contains a second addressee;
determining that a second communication device associated with the second addressee can receive electronic messages of the first type; and
transmitting the electronic message of the first type to the second addressee.

17. The computer-readable storage medium of claim 16, wherein the operations further comprise:
removing, prior to transmitting the electronic message of the second type to the addressee, the second addressee from the electronic message; and
removing, prior to transmitting the electronic message of the first type to the second addressee, the addressee from the electronic message.

18. The computer-readable storage medium of claim 16, wherein the operations further comprise:
responsive to receiving the electronic message of the first type, determining that the electronic message contains a third addressee;
determining that a third communication device associated with the third addressee can receive electronic messages of the first type;
transmitting the electronic message of the first type to the third addressee; and
responsive to receiving a response message from the third addressee, transmitting the response message to a sender of the electronic message and the second addressee.

19. The computer-readable storage medium of claim 15, wherein the first type is MMS and the second type is SMS.

20. The computer-readable storage medium of claim 19, wherein the addressee comprises a Text Control Center.
